(19) United States
(12) Patent Application Publication
(10) Pub. No.: US 2013/0323350 A1
(43) Pub. Date: Dec. 5, 2013

(54) Orally dispersible multi-micronutrient dietary supplement composition and methods of using same

(71) Applicant: Allen Seligson, La Jolla, CA (US)

(72) Inventors: Allen Seligson, La Jolla, CA (US); Sheldon S. Hendler, La Jolla, CA (US)

(21) Appl. No.: 13/653,925

(22) Filed: Oct. 17, 2012

Related U.S. Application Data
(60) Provisional application No. 61/548,166, filed on Oct. 17, 2011.

(51) Int. Cl. A23L 1/29

(52) U.S. Cl. CPC A23L 1/296
USPC 426/2; 426/648; 426/73; 426/96; 426/285

(57) ABSTRACT

The present invention is directed to a novel orally dispersible multi-micronutrient dietary supplement in a tablet dosage form. Use of lipid encapsulated substrates, flavorings, sweeteners and bitter masking agents provides for a dosage that suppresses unpleasant tastes or aftertastes and imparts a pleasant mouth feel when the tablet disperses after being sucked or chewed for several minutes. The combination of lipid encapsulated substrates, oral disintegration and multiple daily dosing schedule provides for improved bioavailability of several crucial micronutrients.

### CROSS REFERENCES

This application claims priority from U.S. Provisional Application No. 61/548,166, filed on Oct. 17, 2011, the contents of which are hereby incorporated by reference herein.

### BACKGROUND OF THE INVENTION

Globally, vitamin and mineral deficiencies affect up to one third of the population and contribute substantially to disease resulting in an increased susceptibility to infections, promotion of birth defects, impairment of intellectual development, blindness and premature mortality. Nutrient supplementation is an affordable proven method to combat this problem however compliance is a major hurdle that needs to be addressed.

Oral administration is the most common method for administration of dietary supplements. They are generally provided in a capsule or compressed tablet dosage form that is swallowed whole, disintegrated in the stomach and absorbed throughout the gastrointestinal tract. Potential problems with this delivery form include gagging, choking, gastroesophageal reflux as well as poor absorption of certain vitamins. Elderly, children and young adults are among the populations that often encounter difficulties in swallowing whole tablets or capsules. There is a significant demand for more patient friendly dosage forms. Eliminating the necessity for swallowing oral nutrient supplements would increase compliance and improve the overall health of nutrient deficient patients.

Fat-soluble nutrients when administered orally and disintegrated in the stomach are only sufficiently absorbed through the intestinal tract in the presence of lipids (fats). This is an additional compliance issue, since most patients do not consume supplements simultaneously with fat containing foods leading to insufficient uptake and poor bioavailability of the lipophilic nutrients. Therefore the presence of lipid carriers as well as prolonged interaction of saliva-dissolved or dispersed fat-soluble nutrients with the oral and esophageal mucosa could potentially lead to increased absorption and bioavailability by reducing first pass metabolism. This phenomenon has been observed for drugs using similar delivery techniques.

There are claims to inventions that offer alternatives to the solid dosage forms for delivery of nutrient supplements but most do not deliver a significant dose per serving, do not have sufficient stability or lack a suitable level of palatability.

There is thus a need for a palatable, orally dispersible, multi-micronutrient supplement to increase dosing compliance and overcome nutrient deficiencies in these non-compliant groups.

### BRIEF SUMMARY OF THE INVENTION

It is the goal of this invention to provide a multi-micronutrient dietary supplement in an orally dispersible tablet dosage form that is palatable, has acceptable mouth feel and delivers a substantial quantity of nutrients after being sucked or chewed for several minutes. The composition contains lipid encapsulated vitamins and minerals, flavorings, sweeteners and bitter masking agents. The vitamin and mineral components promote overall health and the orally dispersible form makes supplement dosing more enjoyable and therefore users more compliant. The tablets and their ingredients are stable for prolonged periods of time at ambient temperature and humidity and can be stored in a metal, plastic or foil receptacle that is conveniently transported in a pocket, purse or other small personal baggage. The dosage form and dosing schedule provide increased absorption and bioavailability of fat-soluble nutrients including vitamins A, D, E and K by release and dispersion in the saliva and subsequent uptake through oral and esophageal mucosal tissue. The remaining nutrients dissolved or suspended in saliva are swallowed for gastric and post gastric absorption.

A method of preparing the multi-micronutrient vitamin and mineral dietary supplement in an orally dispersible tablet dosage form is also provided.

### DETAILED DESCRIPTION OF THE INVENTION

The subject composition contains a lipid encapsulated nutrient blend with excipients including sweeteners(s), flavorings, bitterness masker(s) and diluents/lubricants. The following table (Table 1) indicates the categories of the components and the ranges necessary to yield a pleasant tasting tablet of the composition.

TABLE 1

| Component | Broad Range (w/w %) | Narrow Range (w/w %) |
|---|---|---|
| Sweeteners | 70-90 | 77-83 |
| Flavorings | 1-5 | 2-3.5 |
| Bitter Masking Agent | 0-3 | 0.1-1 |
| Diluents/Lubricants | 0-3 | 0.5-1.5 |
| Lipid Encapsulated | 10-25 | 13-18 |
| Nutrient Blend | | |

The composition can contain one or a mixture of sweeteners including but not limited to glucose, sucrose, lactose, fructose, galactose, fructooligosaccharide, xylitol, erythritol, arabitol, sorbitol, glycerol, mannitol, maltitol, maltose, lactitol, isomalt , aspartame, isomaltulose, rebaudioside A (Reb-A), steviol glycoside, saccharin, dextrose, maltodextrin, sucralose, tagatose.

The composition can contain one or a mixture of flavorings including but not limited to peppermint, spearmint, wintergreen, cinnamon, lemon, lime, orange, vanillin, almond, amaretto, anise, apple, apricot, banana, blackberry, blueberry, bubble gum, butterscotch, caramel, cherry, chocolate, coffee, cotton candy, crème de menthe, eggnog, English toffee, grape, licorice, marshmallow, peach, peanut (butter), pecan, pina colada, pineapple, pistachio, praline, pumpkin, raspberry, root beer, strawberry, tangerine, papaya, cappuccino, kiwi, mango.

The composition can contain one or a mixture of natural or synthetic bitterness blockers/maskers including but not limited to glutamate, inosinic acid, guanylic acid, eriodictyol, ferulic acid, homoeriodictyol, sodium ferulate, sterubin, Virginia Dare Natural Bitter Masker #18886K, Talin, Benecoat, Senomyx S2383, Givaudan Flavors Corp GIV3727and GIV3616.

The composition can contain one or a mixture of diluents/lubricants to ensure proper tableting including but not limited to talc, silica, vegetable stearin, magnesium stearate or stearic acid.

The following table (Table 2) indicates the content range for each individual lipid encapsulated nutrient per serving in the vitamin blend:

TABLE 2

| Nutrient | Broad Range (US RDI %) | Narrow Range (US RDI %) |
|---|---|---|
| Vitamin A | 0-200 | 40-60 |
| Vitamin B1 | 0-200 | 80-120 |
| Vitamin B2 | 0-200 | 80-120 |
| Vitamin B6 | 0-200 | 80-120 |
| Vitamin B12 | 0-1000 | 450-550 |
| Vitamin C | 0-200 | 80-120 |
| Vitamin D | 0-300 | 125-175 |
| Vitamin E | 0-300 | 125-175 |
| Vitamin K | 0-200 | 80-120 |
| Vitamin B3 | 0-200 | 80-120 |
| Folic Acid | 0-200 | 80-120 |
| Biotin | 0-100 | 50-70 |
| Pantothenic Acid | 0-200 | 80-120 |
| Iodine | 0-200 | 80-120 |
| Zinc | 0-200 | 80-120 |
| Copper | 0-200 | 80-120 |
| Manganese | 0-200 | 80-120 |
| Selenium | 0-200 | 80-120 |
| Chromium | 0-200 | 80-120 |
| Molybdenum | 0-200 | 80-120 |
| Co-Enzyme Q10* | 0-100 mg | 20-40 mg |

*Given in milligrams because there is no US RDI established for this component

Nutrient Vitamin A includes but is not limited to one or a combination of alpha carotene, beta carotene, gamma carotene, retnyl acetate, retinyl palmitate, beta-cryptoxanthin.

Nutrient Vitamin B1 includes but is not limited to one or a combination of thiamin hydrochloride, thiamin nitrate.

Nutrient Vitamin B2 is riboflavin.

Nutrient Vitamin B6 includes but is not limited to one or a combination of pyridoxine hydrochloride, pyridoxal 5′-phosphate.

Nutrient Vitamin B12 includes but is not limited to one or a combination of cyanocobalamine, methylcobalamin, (hydroxycolbalamin).

Nutrient Vitamin C includes but is not limited to one or a combination of ascorbic acid, sodium ascorbate, calcium ascorbate, potassium ascorbate, zinc ascorbate, magnesium ascorbate, chromium ascorbate, manganese ascorbate.

Nutrient Vitamin D includes but is not limited to one or a combination of ergocalciferol (Vitamin D2), cholecalciferol (Vitamin D3).

Nutrient Vitamin E includes but is not limited to one or a combination of d-alpha-tocopherol, d-alpha-tocopheryl acetate, d-alpha-tocopheryl succinate, dl-alpha-tocopherol, dl-alpha-tocopheryl acetate, dl-alpha-tocopheryl succinate, gamma-tocopherol, mixed tocopherols, TPGS, dl-alpha-tocopheryl nicotinate, mixed tocotrienols, tocopherol phosphate.

Nutrient Vitamin K includes but is not limited to one or a combination of phytonadione, menaquinones.

Nutrient Vitamin B3 includes but is not limited to one or a combination of Niacinamide, nicotinic acid

Nutrient Folic Acid includes but is not limited to one or a combination of folic acid, folate, 5 -methyltetrahydrofolate, 5 -formyltetrahydrofolate, 10-formyltetrahydrofolate, 5, 10-metheylenetetrahydrofolate 5, 10-methenyltetrahydrofolate, 5 -formiminotetrahydrofolate, 5 ,6,7,8-tetrahydrofolate, dihydrofolate and pteroylpolyglutamates thereof.

Nutrient Pantothenic acid includes but is not limited to one or a combination of pantothenic acid, pantothenol, calcium pantothenate, 4′-phosphopantetheine.

Nutrient Iodine includes but is not limited to one or a combination of potassium iodide, sodium iodide, iodine, iodine caseinate.

Nutrient Zinc includes but is not limited to one or a combination of zinc oxide, zinc acetate, zinc gluconate, zinc sulfate, zinc picolinate, zinc orotate, zinc monomethionine, zinc citrate, zinc aspartate, zinc histidine, zinc cysteine.

Nutrient Copper includes but is not limited to one or a combination of copper oxide, copper picolinate, copper gluconate, copper sulfate, copper glycinate, copper lysinate.

Nutrient Manganese includes but is not limited to one or a combination of manganese sulfate, manganese gluconate, manganese ascorbate, manganese picolinate, manganese amino acid chelates.

Nutrient Selenium includes but is not limited to one or a combination of Sodium selenate, selenomethionine, sodium selenite, methylselenocysteine.

Nutrient Chromium includes but is not limited to one or a combination of chromium picolinate, chromium chloride, chromium nicotinate, chromium citrate.

Nutrient Molybdenum includes but is not limited to one or a combination of sodium molybdate, ammonium molybdate.

Co-Enzyme Q10 is a 1,4-benzoquinone, where Q refers to the quinine or quinol chemical group, and 10 refers to the number of isoprenyl chemical subunits in its tail.

Tablets contain from 0.3 to 2.0g, preferably 0.4 to 1.0g, more preferably from 0.5 to 0.8g of the composition and have a diameter of from 0.2 to 1.0″ preferably 0.3 to 0.8″ more preferably 0.4 to 0.6″.

The number of tablets per serving to deliver a sufficient quantity of nutrients is from 2 to 12 tablets, preferably 3 to 9 tablets and more preferably 5 to 7 tablets. The oral disintegration time of the tablet is from 1 to 12 minutes, preferably 3 to 8 minutes, more preferably 5 to 7 minutes.

The subject composition can per prepared by combining the sweeteners, flavorings, bitter masking agent and lipid encapsulated nutrient blend in a ribbon blender until thoroughly mixed. A solid diluent is then added and the mixture blended. The mixture is sifted and tableted using a tablet press.

### EXAMPLES

### Example 1

Sorbitol (79.92% w/w), Reb-A (0.27% w/w), natural mint oil (2.4% w/w), vanillin (0.38% w/w), bitter masking agent (0.48% w/w) and the lipid encapsulated nutrient blend (15.55% w/w, see Table 3 for contents) are combined in a ribbon blender and mixed for 5 minutes. Magnesium stearate (1.00% w/w) is added and the mixture is allowed to mix for an additional 2 minutes. The mixture is sifted and tableted into 0.67 g tablets with a diameter of 0.50″.

TABLE 3

| Nutrient | Source | US RDI % | Content/0.625 g | |
|---|---|---|---|---|
| Vitamin A | Beta Carotene* | 50.00 | 2500.00 | IU |
| Vitamin B1 | Thiamine Mononitrate | 100.00 | 1.50 | mg |
| Vitamin B2 | Riboflavin | 100.00 | 1.7 | mg |
| Vitamin B6 | Pyridoxine | 100.00 | 2.00 | mg |
| | Hydrochloride | | | |
| Vitamin B12 | Cyanocobalamin | 500.00 | 30.00 | mcg |
| Vitamin C | Sodium Ascorbate | 56.25 | 33.75 | mg |
| Vitamin C | Ascorbic Acid | 43.75 | 26.25 | mg |
| Vitamin D | Cholecalciferol | 150.00 | 600.00 | IU |
| Vitamin E | dl-Alpha Tocopheryl | 150.00 | 45.00 | IU |
| | Acetate | | | |
| Vitamin K | Phytonadione | 100.00 | 80.00 | mcg |
| Vitamin B3 | Niacinamide | 100.00 | 20.00 | mg |
| Folic Acid | Folic Acid | 100.00 | 400.00 | mcg |
| Biotin | Biotin | | 180.0 | mcg |
| Pantothenic | Calcium | 100.00 | 10.00 | mg |
| Acid | D-Pantothenate | | | |
| Iodine | Potassium Iodide | 100.00 | 150.00 | mcg |
| Zinc | Zinc Oxide | 100.00 | 15.00 | mg |
| Copper | Copper Oxide | 100.00 | 2.00 | mg |
| Manganese | Manganese Sulfate | 100.00 | 2.00 | mg |
| Selenium | Sodium Selenate | 100.00 | 70.00 | mcg |
| Chromium | Chromium Picolinate | 100.00 | 120.00 | mcg |
| Molybdenum | Sodium Molybdate | 100.00 | 75.00 | mcg |
| Co-Enzyme Q10* | Co-Enzyme Q10* | * | 30.00 | mg |

| | |
|---|---|
| Q.S. | Sodium Ascorbate |

*No US RDI % established for this component.

### Example 2

Sorbitol (79.92% w/w), Reb-A (0.23% w/w), vanillin (0.38% w/w) and bitter masking agent (0.48% w/w) are combined in a ribbon blender and mixed for 2 minutes. Cinnamon (2.4% w/w), hot cinnamon (1.68% w/w) are added to the mixture and blended for 2 minutes. The lipid encapsulated nutrient blend (14.58% w/w, see Table 3 for contents) is added to the mixture and blended for 2 minutes. Magnesium stearate (0.96% w/w) is added and the mixture is allowed to mix for an additional 2 minutes. The mixture is sifted and tabletted into 0.67g tablets with a diameter of 0.50″.

### Example 3

Sorbitol (79.73% w/w), Reb-A (0.23% w/w), vanillin (0.38% w/w) and bitter masking agent (0.48% w/w) are combined in a ribbon blender and mixed for 2 minutes. Wintergreen flavor (2.85% w/w) and wintergreen oil (1.90% w/w) are added to the mixture and blended for 2 minutes. The lipid encapsulated nutrient blend (14.48% w/w, see Table 3 for contents) is added to the mixture and blended for 2 minutes. Magnesium stearate (0.95% w/w) is added and the mixture is allowed to mix for an additional 2 minutes. The mixture is sifted and tabletted into 0.67g tablets with a diameter of 0.50″.

What is claimed is:

1. An orally dispersible multi-nutrient dietary supplement composition comprising of:
a lipid encapsulated nutrient blend; a sweetener or combination of sweeteners; a
flavoring or combination of flavorings; a bitterness masker or bitterness blocker;
and a diluent or solid lubricant.

2. A composition according to claim 1 comprising of 77-83% sweeteners.

3. A composition according to claim 1 comprising of 2-3.5% flavorings.

4. A composition according to claim 1 comprising of 0.1-1% bitter masking or blocking agent.

5. A composition according to claim 1 comprising of 0.5-1.5% solid diluents or solid lubricants.

6. A composition according to claim 1 comprising of 13-18% lipid encapsulated nutrient blend.

7. A composition according to claim 6 wherein the lipid encapsulated nutrient blend includes Vitamin A, Vitamin B1, Vitamin B2, Vitamin B3, Vitamin B6, Vitamin B12, Vitamin C, Vitamin D, Vitamin E, Vitamin K, Folic Acid, Biotin, Pantothenic Acid, Iodine, Zinc, Copper, Manganese, Selenium, Chromium, Molybdenum, Co-Enzyme Q10.

8. A composition according to claim 2 wherein the sweetener consists of from 99.3 to 99.9% Sorbitol and 0.1 to 0.7% Reb-A.

9. A composition according to claim 3 wherein the flavoring consists of 80 to 90% peppermint oil and 10 to 20% vanillin.

10. A composition according to claim 5 wherein the solid lubricant is magnesium stearate.

11. A composition according to claim 7 wherein:
Vitamin A is in the form of beta-carotene;
Vitamin B1 is in the form of thiamine mononitrate;
Vitamin B2 is in the form of riboflavin;
Vitamin B6 is in the form of pyridoxine hydrochloride;
Vitamin B12 is in the form of cyanocobalamin;
Vitamin C is in the form of sodium ascorbate and ascorbic acid;
Vitamin D is in the form of cholecalciferol;
Vitamin E is in the form of dl-alpha tocopheryl acetate;
Vitamin K is in the form of phytonadione;
Vitamin B3 is in the form of niacinamide;
Pantothenic Acid is in the form of calcium D-pantothenate;
Iodine is in the form of potassium iodide;
Zinc is in the form of zinc oxide;
Copper is in the form of copper oxide;
Manganese is in the form of manganese sulfate;
Selenium is in the form of sodium selenate;
Chromium is in the form of chromium picolinate;
Molybdenum is in the form of sodium molybdate.

12. A composition according to claim 1 where the contents are pressed into a tablet.

13. A composition according to claim 12 where the tablet weighs 0.5 to 0.8 g with a diameter 0.4 to 0.6″.

14. A composition according to claim 13 where the oral disintegration time of the tablet is from 5 to 7 minutes.

15. A composition according to claim 13 wherein the number of tablets per serving to deliver sufficient quantities of nutrients is from 5 to 7 tablets.

16. A composition according to claim 15 where said tablets are stored in a metal, plastic or foil receptacle that is conveniently transported in a pocket, purse or other small personal baggage.

17. A method for preparing an orally dispersible multi-nutrient dietary supplement composition according to claim 1 wherein:
the sweeteners, flavorings, bitter masking agent and lipid encapsulated nutrient blend are combined in a blender and blended until thoroughly mixed;
a solid lubricant is added and blended until thoroughly mixed.

18. A method according to claim 17 where said mixture is sifted and then pressed into a tablet.

19. A method of treating vitamin and mineral deficiency comprising of consuming an orally dispersible multi-micronutrient dietary supplement in a tablet dosage form according to claim 1.

20. A method of dosing an orally dispersible multi-micronutrient dietary supplement in a tablet dosage form according to claim 1 wherein 5 to 7 tablets are consumed with in a 12 to 24 hour time period.
